(19) United States
(12) Patent Application Publication
(10) Pub. No.: US 2016/0178835 A1
(43) Pub. Date: Jun. 23, 2016

(54) DISPLAY DEVICE

(71) Applicant: Samsung Display Co., Ltd., Yongin-City (KR)

(72) Inventors: Jae-hyun KIM, Seoul (KR); Tae-hoon KIM, Asan-si (KR); Ickkyu JANG, Seoul (KR); Taekyoung KIM, Gwangmyeong-si (KR)

(21) Appl. No.: 14/716,708

(22) Filed: May 19, 2015

(30) Foreign Application Priority Data
Dec. 23, 2014 (KR) 10-2014-0187132

(51) Int. Cl. F21V 8/00

(52) U.S. Cl. CPC G02B 6/0083; G02B 6/009

(57) ABSTRACT

Disclosed is a display device including: a display panel configured to display an image; a light emission unit configured to output light to the display panel for displaying the image to the display panel; and a flexible circuit board configured to connect the display panel with the light emission unit. The display panel may include: a display area where the image is displayed; and a non-display area where a plurality of dummy lines is disposed. A drive dummy line of the dummy lines may be electrically connected with the light emission unit through the flexible circuit board.

### CROSS-REFERENCE TO RELATED APPLICATIONS

A claim for priority under 35 U.S.C. §119 is made to Korean Patent Application No. 10-2014-0187132 filed Dec. 23, 2014, in the Korean Intellectual Property Office, the entire contents of which are hereby incorporated by reference.

### BACKGROUND

The present disclosure relates to a display device, and more particularly, relates to a display device in which a backlight unit is electrically connected with a display panel.

A non-selfluminous display device, such as a liquid crystal display, typically includes a backlight unit to generate light, and a display panel to display images by using the light. The backlight unit includes a light source that receives power supplied from an external system. The light source may be used with a Cold Cathode Fluorescent Lamp (CCFL) or a plurality of Light Emission Diodes (LEDs). In recent years, LEDs are replacing CCFL due to their lower power consumption and higher luminance.

LEDs included in a backlight unit for supplying light to the display panel may be classified as a direct type or an edge type. In an edge-type backlight unit, one or more LEDs are disposed along a side of the display panel. Such an edge-type backlight unit operates to irradiate light over the whole surface of the display panel by means of a light guiding plate. In a direct-type backlight unit, on the other hand, LEDs are disposed under the display panel. Such a direct-type backlight unit operates to irradiate light over the whole surface of the display panel from a planar light source that has the same area as the display panel.

Generally, the edge-type backlight unit is inferior to the direct-type backlight unit because it tends to generate more heat while emitting light.

### SUMMARY

One aspect of the embodiments of the present system and method is to provide a display device having a reduced rate of heat generation.

In an embodiment, a display device may include: a display panel configured to display an image; a light emission unit configured to output light, which is necessary for displaying the image, to the display panel; and a flexible circuit board configured to connect the display panel with the light emission unit, wherein the display panel includes: a display area where the image is displayed; and a non-display area where a plurality of dummy lines is disposed, wherein a drive dummy line of the dummy lines is electrically connected with the light emission unit through the flexible circuit board.

In an embodiment, the display device may further include a dimming controller configured to generate a dimming control signal to adjust brightness of the light, wherein the dimming controller is configured to output the dimming control signal to the drive dummy line.

In an embodiment, the dimming control signal may be provided to the light emission unit through the flexible circuit board electrically connected with the drive dummy line.

In an embodiment, the display device may further include a drive circuit board in which the dimming controller is disposed.

In an embodiment, the display device may further include a plurality of source circuit boards configured to electrically connect the drive circuit board with the display panel, wherein at least one of the source circuit boards is electrically connected with the dimming controller.

In an embodiment, the source circuit boards may respectively include source drive chips to output a plurality of data voltages used for displaying the image to the display panel.

In an embodiment, each of the source circuit boards may include a plurality of signal lines, wherein a drive signal line of the signal lines formed in the at least one source circuit board may be electrically connected with the drive dummy line.

In an embodiment, one end of the drive signal line may be connected with the drive dummy line and the other end of the drive signal line may be electrically connected with the dimming controller.

In an embodiment, the light emission unit and the drive circuit board may be physically connected with opposite edge sides of the display panel.

In an embodiment, the light emission unit may be connected with an edge side of the display panel extending in a first direction and the drive circuit board is connected with an edge side of the display panel extending in a second direction intersecting the first direction.

In an embodiment, the light emission unit may include: a plurality of light emission diodes configured to output the light; and a printed circuit board on which the light emission diodes are disposed, wherein the printed circuit board may be electrically connected with the flexible circuit board.

In an embodiment, one end of the flexible circuit board may be bonded to the printed circuit board and another end of the flexible circuit board may be bonded to a non-display area of the display panel.

In an embodiment, the display device may further include a connector disposed in the printed circuit board.

In an embodiment, one end of the flexible circuit board may be electrically connected with the connector and another end of the flexible circuit board may be bonded to a non-display area of the display panel.

In an embodiment, the light emission unit may be an edge type.

According to embodiments of the present system and method, a backlight unit may be electrically connected with a display panel through one of the sides of the display panel. Especially, the backlight unit may be electrically connected with a side of the display panel where the rate of heat generation is smaller. As a result, it is possible to prevent a specific part of a display device from generating excessive heat.

### BRIEF DESCRIPTION OF THE FIGURES

FIG. 1 is an exploded oblique view of a display device according to an embodiment of the present system and method.

FIG. 2 is a block diagram illustrating the display device shown in FIG. 1.

FIG. 3 is a block diagram illustrating a light emission unit of the backlight unit shown in FIG. 1.

FIG. 4 is a perspective diagram illustrating an interconnection feature between the dimming controller and the backlight unit in accordance with an embodiment of the present system and method.

FIG. 5 is a perspective diagram illustrating an interconnection feature between the dimming controller and the backlight unit in accordance with another embodiment of the present system and method.

### DETAILED DESCRIPTION

The present system and method may include various modifications and be embodied in different forms, some of which are illustrated in the drawings and described in the specification hereinbelow. The present system and method, however, are not limited only to the illustrated embodiments. Rather, these embodiments are provided as examples to help convey the concept of the present system and method to those skilled in the art. Thus, those of ordinary skill in the art would understand that available modifications, equivalents or replacements are within the spirit and scope of the present system and method.

In delineating the accompanied drawings, the same or similar reference signs are used for the same or similar elements. Throughout the drawings, the dimensions of the elements may be exaggerated and may not be drawn to scale. Although the terms “first”, “second”, etc., may be used herein to describe various elements, components, regions, layers and/or sections, these elements, components, regions, layers and/or sections are not limited by these terms. These terms are only used to distinguish one element, component, region, layer or section from another element, component, region, layer or section. Thus, a first element, component, region, layer or section discussed below may be referred to as a second element, component, region, layer or section without departing from the teachings of the present disclosure. Singular terms may be understood as implying plurality thereof unless the context clearly indicates otherwise.

The terms “comprise”, “include” and/or “have,” when used in this specification, specify the presence of stated features, integers, steps, operations, elements, and/or components, but do not preclude the presence or addition of one or more other features, integers, steps, operations, elements, components, and/or groups thereof.

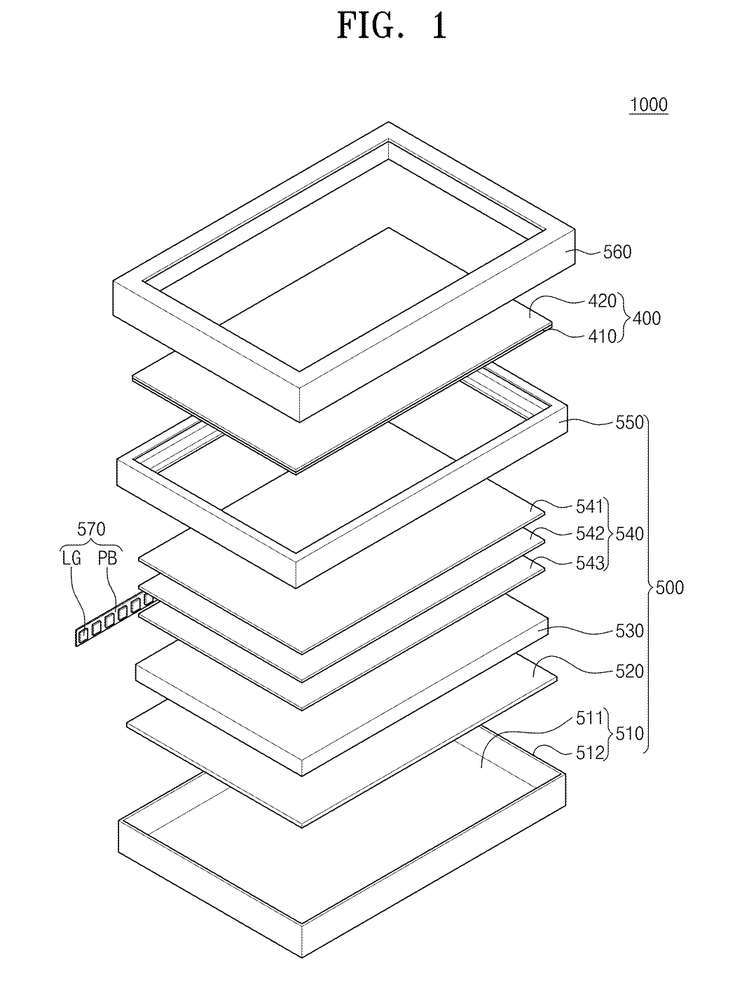

FIG. 1 is an exploded oblique view of a display device according to an embodiment of the present system and method.

Referring to FIG. 1, the display device 1000 may include a backlight unit 500 and a display panel 400. The backlight unit 500 may emit light, and the display panel 400 may be supplied with the light from the backlight unit 500 to display images.

According to an embodiment, the display panel 400 may be a kind of liquid crystal panel. In this configuration, the display panel 400 may include a first substrate 410 having a plurality of pixel electrodes, a second substrate 420 having a common electrode, and a liquid crystal layer (not shown) interposed between the first and second substrates 410 and 420.

Additionally, according to an embodiment, the display panel 400 may be a kind of electrowetting display panel. In this configuration, the display panel 400 may include a fluid layer (not shown), instead of the liquid crystal layer, interposed between the first and second substrates 410 and 420. The fluid layer may include two kinds of fluids that are incapable of mixing with each other, one of which may have an electrical polarity.

In detail, the backlight unit 500 may include a receptacle 510, a reflection plate 520, a light guiding plate 530, a plurality of sheets 540, a mold frame 550, a cover member 560, and a light emission unit 570.

The receptacle 510 may include a bottom 511 and a plurality of sidewalls 512 extending from the bottom 511 to accommodate the other elements of the backlight unit 500. According to an embodiment, the light emission unit 570 may be disposed on an inner side of the sidewalls 512, but the present system and method are not restrictive thereto. That is, the light emission unit 570 may include a plurality of units and be disposed on other sidewalls of the plurality of sidewalls 512.

The reflection plate 520 may be disposed between the bottom 511 of the receptacle 510 and the light guiding plate 530 and include a material that is capable of reflecting light, such as polyethylene terephthalate (PET) or aluminum. Therefore, light generated from the light emission unit 570 but not incident directly on the light guiding plate 530 may be reflected towards the light guiding plate 530 by the refection plate 520.

The light guiding plate 530 may be accommodated in the receptacle 510 such that a side of the light guiding plate 530 faces the light emission unit 570. That is, the light guiding plate 530 may receive incident light output from a plurality of light emission diodes LG of the light emission unit 570 through its side. The light guiding plate 530 may guide the incident light to exit toward the display panel 400.

A plurality of the sheets 540 may be disposed on the top of the light guiding plate 530. The plurality of sheets 540 may include optical sheets and a protection sheet. The optical sheets may adjust the path of the light exiting from the light guiding plate 530 and incident on the display panel 400. The protection sheet may protect the surface of the display panel 400.

In detail, the plurality of sheets 540 may include a protection sheet 541 to protect the back of the display panel 400, a prism sheet 542 to improve luminance at the front, and a spread sheet 543 to diffuse light.

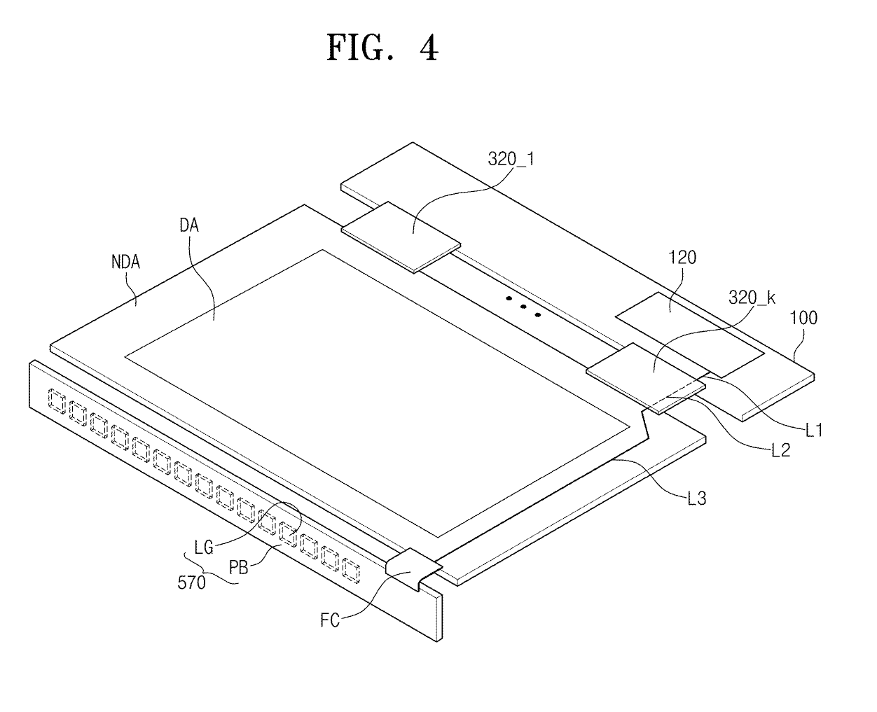

The mold frame 550 may be combined with the receptacle 510 and support the edge of the light guiding plate 530 on the bottom 511 of the receptacle 510. A part of the mold frame 550 may extend along a direction parallel with the bottom 511. Additionally, the plurality sheets 540 and the display panel 400 may be settled in a part of the mold frame 550. The light emission unit 570 may generate light to be used in displaying images on the display panel 400. The light emission unit 570 may include a printed circuit board PB, light emission diodes LG, and a flexible circuit board FC (see FIG. 4). The light emission diodes LG and the flexible circuit board FC may be disposed on the printed circuit board PB. The light emission diodes LG may emit light by means of power that is received through the flexible circuit board FC. Additionally, the light emission diodes LG may adjust output light intensity in response to a dimming control signal received through the flexible circuit board FC.

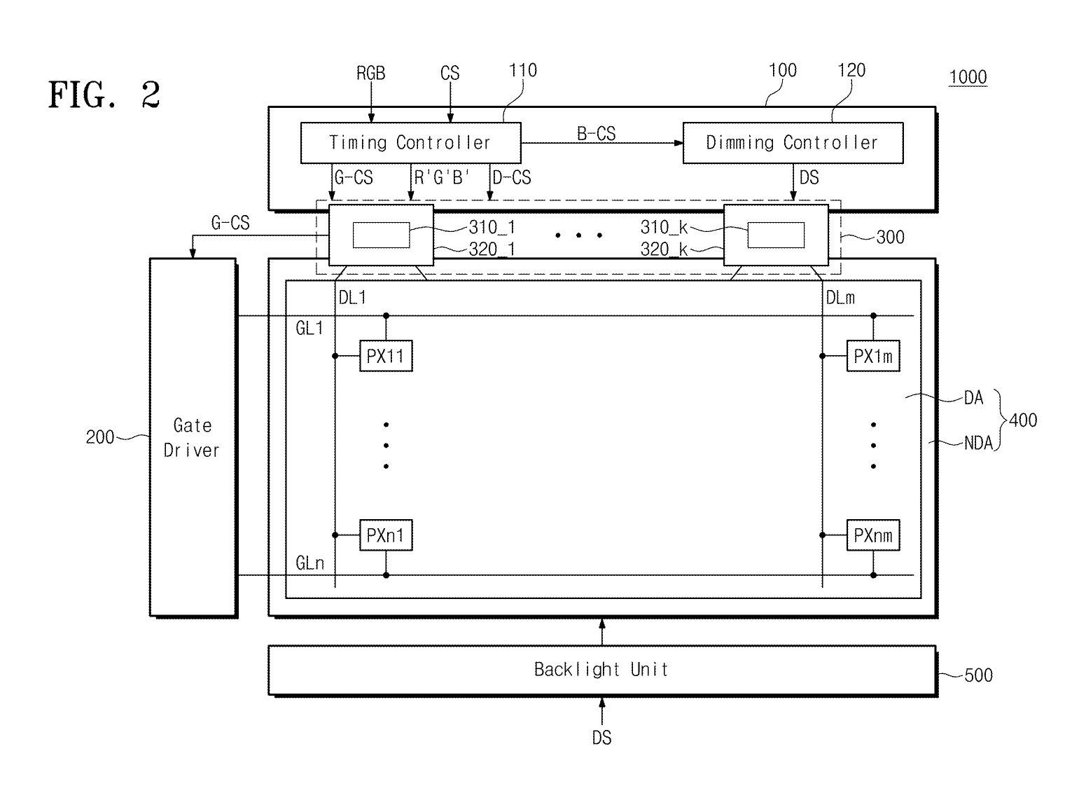

FIG. 2 is a block diagram illustrating the display device shown in FIG. 1.

Referring to FIG. 2, the display device 1000 may further include, in addition to the display panel 400 and the backlight unit 500 described in conjunction with FIG. 1, a drive circuit board 100, a gate driver 200, and a data driver 300.

The drive circuit board 100 may include a timing controller 110 that controls an overall operation of the display device 1000 and a dimming controller 120 that controls an operation of the backlight unit 500. The timing controller 110 may receive pluralities of image signals RGB and control signals CS from an external source. The timing controller 110 may convert the data format of the image signals RGB to a data format appropriate to the interface between the data driver 300 and the timing controller 110. A plurality of image signals R′G′B′ may be supplied to the data driver 300.

The timing controller 110 may output a plurality of drive signals in response to the external control signals CS. For example, the timing controller 110 may generate a data control signal D-CS, a gate control signal G-CS, and a backlight control signal B-CS as the plurality of drive signals. The data control signal D-CS may include an output start signal, a clock signal, a line latch signal, so on. The gate control signal G-CS may include a vertical start signal, a vertical clock-bar signal, and so on. The timing controller 110 may transfer the data control signal D-CS to the data driver 300 and transfer the gate control signal G-CS to the gate driver 200. The timing controller 110 may transfer the gate control signal G-CS to the gate driver 200 by way of one or more of a plurality of source circuit boards 320_1˜320_k of the data driver 300.

The dimming controller 120 may generate a dimming control signal DS to control an operation of the backlight unit 500. For example, the backlight unit 500 may control the amount of light that is emitted toward the display panel 400 in response to the dimming control signal DS.

When the display device 1000 is activated, heat is usually generated. Especially, if the drive circuit board 100 is disposed to overlap with the light emission unit 570 (see FIG. 1) of the backlight unit 500, heat generation would be concentrated in the area where the drive circuit board 100 overlaps with the light emission unit 570.

According to an embodiment, the dimming controller 120 may transfer the dimming control signal DS to the light emission unit 570 by way of the data driver 300 and the display panel 400. That is, the light emission unit 570 may be disposed at a side of the display panel 400 that does not overlap with the drive circuit board 100 and the data driver 300.

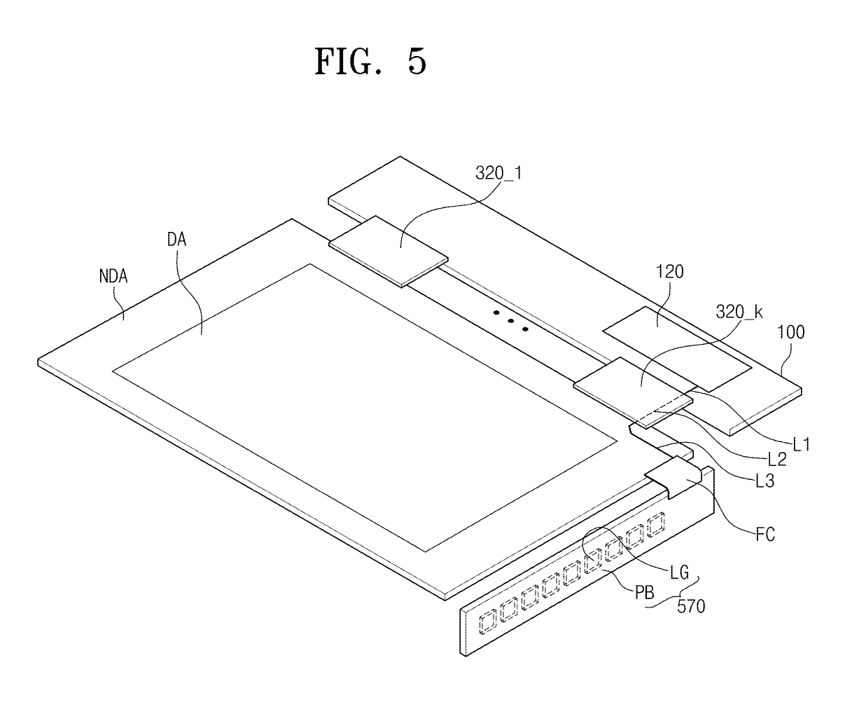

Additionally, in an embodiment, the light emission unit 570 may be electrically connected with the display panel 400 through the flexible circuit board FC. Thus, the dimming control signal DS output from the dimming controller 120 may be applied to the light emission unit 570 by way of the data driver 300 and the display panel 400. This configuration is described further below with reference to FIGS. 4 and 5.

The gate driver 200 may generate a plurality of gate signals in response to the gate control signal G-CS that is applied from the timing controller 110. The gate signals are sequentially supplied to pixels PX11˜PXnm in the unit of row by way of gate lines GL1˜GLn. Thus, the pixels PX11˜PXnm may be drive in the unit of row.

The data driver 300 is supplied with the image signals R′G′B′, the data control signal D-CS, and a switching control signal SQ (not shown) from the timing controller 110. The data driver 300 may generate a plurality of data voltages that correspond to the image signals R′G′B′ in response to the data control signal D-CS.

The data driver 300 may supply the data voltages to the plurality of pixels PX11˜PXnm through data lines DL1˜DLm.

The data driver 300 may include a plurality of source drive chips 310_1˜310_k. Hereupon, k is a positive integer larger than 0 but smaller than m. The source drive chips 310_1˜310_k may be installed on the source circuit boards 320_1˜320_k. The source circuit boards 320_1˜320_k may be connected with a non-display area NDA that is adjacent to the top of a display area DA and the drive circuit board 100. As an embodiment, the source circuit boards 320_1˜320_k may be implemented in flexible circuit boards.

Additionally, while the source drive chips 310_1˜310_k may be formed as Tape Carrier Packages (TCPs) set on the source circuit boards 320_1˜320_k, the present system and method are not restricted thereto. In some embodiment, the source drive chips 310_1˜310_k may be installed on the source circuit boards 320_1˜320_k as Chips-On-Glass (COG).

The display panel 400 may include the display area DA where an image is displayed and the non-display area NDA disposed around the display area DA.

The display panel 400 may include the plurality of pixels PX11˜PXnm arranged in the display area DA. Additionally, the display panel 400 may include the gate lines GL1˜GLn and the data lines DL1˜DLm, which may intersect the gate lines GL1˜GLn with an insulation layer disposed between them. In this configuration, the gate lines GL1˜GLn may extend along a first direction while the data lines DL1˜DLm may extend along a second direction intersecting the first direction.

The gate lines GL1˜GLn may be connected with the gate driver 200 and sequentially receive the gate signals therefrom. The data lines DL1˜DLm may be connected with the data driver 300 and receive the data voltages therefrom.

The pixels PX11˜PXnm may be formed at regions where the gate lines GL1˜GLn intersect the data lines DL1˜DLm. Therefore, the pixels PX11˜PXnm may be arranged in n-numbered rows and m-numbered columns, where n and m are positive integers larger than 0.

The pixels PX11˜PXnm may be connected correspondingly with the gate and data lines GL1˜GLn and DL1˜DLm, respectively. When the pixels PX11˜PXnm are supplied with data voltages through the data lines DL1˜DLm in response to the gate signals applied from the gate lines GL1˜GLn, the pixels PX11˜PXnm may display gray scales corresponding to the data voltages.

The backlight unit 500 may supply light to the display panel 400. The backlight unit 500 may include the plurality of light emission diodes LG. Especially, according to an embodiment, the backlight unit 500 may include a plurality of light emission strings (not shown) including a plurality of the light emission diodes LG serially coupled with each other.

According to an embodiment, the light emission unit 570 included in the backlight unit 500 may be electrically connected with a side of the non-display area NDA that does not overlap with the drive circuit board 100 and the data driver 300.

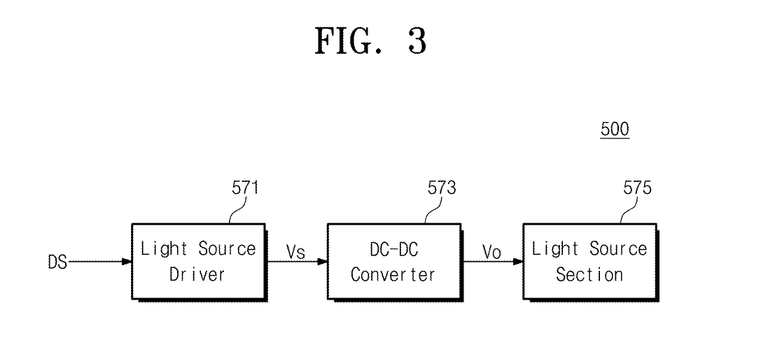

FIG. 3 is a block diagram illustrating the light emission unit of the backlight unit shown in FIG. 1.

Referring to FIG. 3, the light emission unit 570 may include a light source driver 571, a DC-DC converter 573, and a light source section 575.

The light source driver 571 may be electrically connected with the DC-DC converter 573 and receive the dimming control signal DS from the dimming controller 120 (see FIG. 2). The light source driver 571 may generate a drive signal Vs for controlling the brightness of the light being emitted from the light source section 575 in response to the dimming control signal DS. The light source driver 571 may transfer the drive signal Vs to the DC-DC converter 573.

The DC-DC converter 573 may receive an input voltage from an external source. The input voltage externally supplied may be received through the flexible circuit board FC that connects the display panel 400 with the light emission unit 570. Additionally, the DC-DC converter 573 may receive the drive signal Vs from the light source driver 571 and convert the input voltage into an output voltage Vo in response to the drive signal Vs. The DC-DC converter 573 may supply the output voltage Vo to the light source section 575. The output voltage Vo may be used for an operation of the light source section 575.

The light source section 575 may receive the output voltage Vo from the DC-DC converter 573. The light source section may include the plurality of light emission strings in which a plurality of light emission diodes are serially connected with each other, and generate light using the received drive voltage Vo.

FIG. 4 is a perspective diagram illustrating an interconnection feature between the dimming controller and the backlight unit in accordance with an embodiment of the present system and method. FIG. 5 is a perspective diagram illustrating an interconnection feature between the dimming controller and the backlight unit in accordance with another embodiment of the present system and method.

Referring to FIGS. 2 and 4, the dimming controller 120 may be disposed on the drive circuit board 100. The dimming controller 120 may be electrically connected with the source circuit board 320_k through a first signal line L1 disposed on the drive circuit board 100. While the first signal line L1 is exemplarily described as coupling with one of the plurality of source circuit boards 320_1˜320_k, the present system and method are not restricted thereto. The first signal line L1 may be connected with any one of the source circuit boards 320_1˜320_k. The dimming controller 120 may output the dimming control signal DS to the source circuit board 320_k through the first signal line L1.

The source circuit board 320_k may have a plurality of drive signal lines and a plurality of dummy signal lines arranged thereon. Although not shown, the drive signal lines may electrically connect the drive circuit board 100 with the source drive chip 310_k laid on the source circuit board 320_k. Additionally, the drive signal lines may electrically connect the source drive chip 310_k with the display panel 400. The drive signal lines electrically connecting the source drive chip 310_k with the display panel 400 may be electrically connected with the data lines DL1˜DLm disposed in the display panel 400.

The dummy signal lines may connect the drive circuit board 100 directly with the display panel 400. In other words, the dummy signal lines may transfer a signal, which is output from the drive circuit board 100, directly to the display panel 400 bypassing the source drive chip. Exemplarily, FIG. 4 shows one of the dummy signal lines, referred to as a second signal line L2, is laid on the source circuit board 320_k.

The second signal line L2 may be electrically connected with the first signal line L1. In this configuration, the first and second signal lines L1 and L2 may be electrically connected each other. Additionally, the second signal line L2 may be electrically connected through a pad with a third signal line L3 that is placed in the display panel 400.

A plurality of dummy lines for transferring signals may be disposed in the non-display area NDA of the display panel 400. Exemplarily shown in FIG. 4 is that one of the dummy lines, referred to as a first signal line L3, is laid in the non-display area NDA.

The third signal line L3 may be electrically connected with the second signal line L2 and the flexible circuit board FC. In this configuration, the third signal line L3 may be electrically connected with each of the second signal line L2 and the flexible circuit board FC through a pad. The third signal line L3 may receive the dimming control signal DS, which is output from the dimming controller 120, by way of the second signal line L2 and transfer the dimming control signal DS to the flexible circuit board FC.

The flexible circuit board FC may electrically connect the light emission unit 570 with the third signal line L3. Then, the flexible circuit board FC may transfer the dimming control signal DS to the light emission unit 570 from the third signal line L3.

The printed circuit board PB of the light emission unit 570 may be electrically connected with the display panel 400 by way of the flexible circuit board FC. In this configuration, one end of the flexible circuit board FC may be bonded to the printed circuit board PB, while the other end of the flexible circuit board FC may be bonded to the non-display area NDA of the display panel 400. In addition, although not shown, a connector may be disposed in the printed circuit board PB. In this configuration, one end of the flexible circuit board FC may be electrically connected with the connector in the printed circuit board PB, while the other end of the flexible circuit board FC may be bonded to the non-display area NDA of the display panel 400.

According to the above-described embodiment, the printed circuit board PB may receive the dimming control signal DS transferred through the third signal line L3 from the flexible circuit board FC. Then, the plurality of light emission diodes LG included in the light emission unit 570 may correspondingly output light in response to the dimming control signal DS. The light output from the light emission diodes LG may be transmitted to the display panel 400 through the light guiding plate 530 (see FIG. 1).

According to an embodiment, the light emission unit 570 may be disposed along one of two long sides of the display panel 400 in which the data driver 300 is not disposed along the one side.

As described above, the light emission unit 570 according to embodiments of the present system and method may be disposed one of the long sides of the display panel 400. Additionally, the light emission unit 570 may be electrically connected with the display panel 400 through a dummy line laid on the non-display area NDA and receive the dimming control signal DS therefrom.

With the aforementioned configuration, it may be possible to reduce an overall rate of heat generation in the display device 1000. Particularly, since the light emission unit 570 does not overlap with the data driver 300 and the drive circuit board 100, it may prevent heat generation from being concentrated at a specific area of the display device 1000.

Additionally, while the embodiment of FIG. 4 shows a single dummy line of the non-display area NDA connecting the printed circuit board PB with the drive circuit board 100, the present system and method are not restricted thereto. For example, one or more dummy lines of the non-display area NDA may be used for connecting the printed circuit board PB with the drive circuit board 100.

Exemplarily, a dummy line for transferring an input voltage that is supplied to the DC-DC converter 573 shown in FIG. 3 may be disposed in the non-display area NDA. In this configuration, the dummy line transferring the input voltage may be electrically connected with signal lines included in the drive circuit board 100 and the source drive board 320_k to receive the input voltage. Additionally, the dummy line transferring the input voltage may transfer the received input voltage to the printed circuit board PB through the flexible circuit board FC.

Now referring to FIGS. 2 and 5, FIG. 5 shows a configuration in which the light emission unit 570 is disposed along one of two short sides of the display panel 400, as opposed to the configuration of FIG. 4 in which the light emission unit 570 is disposed along one of two long sides. That is, FIG. 5 may be the same with FIG. 4 in configuration, except the side along which the light emission unit 570 is disposed. Thus, it is not further described.

While the present system and method are described above with reference to exemplary embodiments, those of ordinary skill in the art would understand that various changes and modifications may be made without departing from the spirit and scope of the present system and method set forth in the claims. Therefore, it should be understood that the above embodiments are not limiting but illustrative.

What is claimed is:

1. A display device comprising:
a display panel configured to display an image;
a light emission unit configured to output light to the display panel for displaying the image; and
a flexible circuit board configured to connect the display panel with the light emission unit,
wherein the display panel includes: a display area where the image is displayed; and a non-display area where a plurality of dummy lines is disposed, wherein a drive dummy line of the dummy lines is electrically connected with the light emission unit through the flexible circuit board.

2. The display device according to claim 1, further comprising a dimming controller configured to generate a dimming control signal to adjust brightness of the light,
wherein the dimming controller is configured to output the dimming control signal to the drive dummy line.

3. The display device according to claim 2, wherein the dimming control signal is provided to the light emission unit through the flexible circuit board electrically connected with the drive dummy line.

4. The display device according to claim 2, further comprising a drive circuit board in which the dimming controller is disposed.

5. The display device according to claim 4, further comprising a plurality of source circuit boards configured to electrically connect the drive circuit board with the display panel,
wherein at least one of the source circuit boards is electrically connected with the dimming controller.

6. The display device according to claim 5, wherein the source circuit boards respectively include source drive chips to output a plurality of data voltages used for displaying the image to the display panel.

7. The display device according to claim 5, wherein each of the source circuit boards includes a plurality of signal lines,
wherein a drive signal line of the signal lines formed in the at least one source circuit board is electrically connected with the drive dummy line.

8. The display device according to claim 7, wherein one end of the drive signal line is connected with the drive dummy line and the other end of the drive signal line is electrically connected with the dimming controller.

9. The display device according to claim 4, wherein the light emission unit and the drive circuit board are physically connected with opposite edge sides of the display panel.

10. The display device according to claim 4, wherein the light emission unit is physically connected with an edge side of the display panel extending in a first direction and the drive circuit board is physically connected with an edge side of the display panel extending in a second direction intersecting the first direction.

11. The display device according to claim 2, wherein the light emission unit includes:
a plurality of light emission diodes configured to output the light; and
a printed circuit board on which the light emission diodes are disposed,
wherein the printed circuit board is electrically connected with the flexible circuit board.

12. The display device according to claim 11, wherein one end of the flexible circuit board is bonded to the printed circuit board and another end of the flexible circuit board is bonded to a non-display area of the display panel.

13. The display device according to claim 11, further comprising a connector disposed in the printed circuit board.

14. The display device according to claim 13, wherein one end of the flexible circuit board is electrically connected with the connector and another end of the flexible circuit board is bonded to a non-display area of the display panel.

15. The display device according to claim 1, wherein the light emission unit is an edge type.
